(19) United States
(12) Patent Application Publication
(10) Pub. No.: US 2016/0052114 A1
(43) Pub. Date: Feb. 25, 2016

(54) Piston Ring Removal Tool

(71) Applicant: Caterpillar Inc., Peoria, IL (US)

(72) Inventors: Aaron Claver, Congerville, IL (US); Bradley Hill, Dumas, MS (US); Nathaniel Nooner, Corinth, MS (US); Kenneth Mask, Rienzi, MS (US); Steven Tucker, Selmer, TN (US); Michael Gunn, Walnut, MS (US); James Butler, Iuka, MS (US)

(73) Assignee: Caterpillar Inc., Peoria, IL (US)

(21) Appl. No.: 14/466,236

(22) Filed: Aug. 22, 2014

(51) Int. Cl. B25B 27/12

(52) U.S. Cl. CPC B25B 27/12

(57) ABSTRACT

The disclosure relates to a piston ring removal tool and methods of using the same. One method includes disposing a tool between a first piston ring and a piston associated with the piston ring and rotating the piston, wherein the tool engages the first piston ring and separates at least a portion of the first piston ring from the piston.

### TECHNICAL FIELD

The disclosure relates generally to a tool configured for use with piston rings and, more particularly, to a tool configured for use in removing piston rings from a piston associated with an internal combustion engine.

### BACKGROUND

The fields of machine component salvaging and remanufacturing have grown significantly in recent years. Systems and components that only recently would have been scrapped are now repaired and/or refurbished and returned to service. Internal combustion engines have many different parts that may be remanufactured. When such an engine is taken out of service and dismantled for remanufacturing, various parts, such as pistons, may be reused, while others are scrapped.

In the case of pistons, it is desirable, in many instances, to efficiently process pistons so that they can be remanufactured to a condition as good or better than new. A step in the process of remanufacturing pistons is to remove piston rings, while causing minimal to no additional damage to the piston. Several techniques and tools have been used to try to efficiently remove piston rings. Most techniques remove piston rings one at a time using a tool that expands the piston ring over the crown of the piston. There are few tools that provide for multiple piston ring removal. The multiple piston ring removal tools usually are designed for a piston of a specific and very limited dimension and are not designed for efficiently removing piston rings with high volume processing, which may be done at a piston remanufacturing facility. In addition, current multiple piston ring removal tools often have a high risk of damaging the piston.

U.S. Pat. No. 1,412,953 to Charles is directed to a tool for facilitating the removal and replacement of piston rings. Charles proposed a tool with a plurality of slender arms that may be inserted between the ring and the piston at multiple sides of the piston. When the arms are inserted beneath the piston rings they may be separated outwardly to occupy positions substantially equidistant from each other. In this separating operation the one or more piston rings are expanded sufficiently to permit of its removal from the piston. While Charles may provide a strategy for removing multiple rings, there remains a need for a less time consuming method for removing multiple piston rings. Furthermore, there remains a need for a universal tool for removing piston rings of varying size. Accordingly, the presently disclosed piston ring removal tool is directed at overcoming one or more of these disadvantages in currently available methods, systems, and apparatuses for piston ring removal.

### SUMMARY

It is to be understood that both the following summary and the following detailed description are exemplary and explanatory only and are not restrictive. Provided are methods and systems for, in one aspect, removal of an item such as a piston ring from a piston.

In one method, a tool may be disposed between a first piston ring and a piston associated with the piston ring. The piston may be caused to rotate such that the tool engages the first piston ring and separates at least a portion of the first piston ring from the piston.

In another method, a tool may be disposed between a plurality of piston rings and a piston. The tool may be positioned to cause at least a portion of one or more of the plurality of piston rings to be disposed adjacent a top land of the piston. The piston may be rotated to at least partially separate the plurality of piston rings from the piston.

In an aspect, a removal system may include a rotatable surface configured to rotate about an axis and a removal tool including a tapered portion. As an example, the tapered portion of the removal tool may be configured to engage an item disposed on the rotatable surface. As a further example, a rotation of the rotatable surface may cause the removal tool to separate a first portion of the item from a second portion of the item.

### BRIEF DESCRIPTION OF THE DRAWINGS

FIG. 1 is a perspective view of an exemplary ring removal system according to an aspect of the disclosure.

FIG. 2A is a perspective view of an exemplary removal tool according to an aspect of the disclosure.

FIG. 2B is an enlarged side view of an end portion of the removal tool of FIG. 2A.

FIG. 2C is an enlarged top view of an end portion of the removal tool of FIG. 2A.

FIG. 3A is a perspective view of an exemplary tool holder and a removal tool shown in a removal position according to an aspect of the disclosure.

FIG. 3B is an enlarged perspective view of the exemplary tool holder of FIG. 3A.

FIG. 4 is a perspective view of an exemplary ring removal system showing a clamp according to an aspect of the disclosure.

FIG. 5A is a perspective view of an exemplary ring removal system showing a clamp according to another aspect of the disclosure.

FIG. 5B is a perspective view of the exemplary ring removal system of FIG. 5A rotated 180 degrees from the view of FIG. 5A.

FIG. 6 is a perspective view of an exemplary ring removal system showing a clamp according to yet another aspect of the disclosure.

FIG. 7A is a perspective view of the exemplary ring removal system of FIG. 6 showing a piston crown-bore assembly.

FIG. 7B is a perspective view of the exemplary ring removal system of FIG. 6 rotated 180 degrees from the view of FIG. 7A.

FIG. 8 illustrates a block diagram of an exemplary method.

FIG. 9 is a perspective view of the exemplary ring removal system of FIG. 6 showing the removal tool in an insert position.

FIG. 10 is a perspective view of the exemplary ring removal system of FIG. 6 showing the removal tool in a removal position.

FIG. 11 is a perspective view of the exemplary ring removal system of FIG. 6 showing a plurality of piston rings at least partially separated from a piston.

FIG. 12 illustrates a block diagram of an exemplary method.

FIG. 13 illustrates a block diagram of an exemplary method.

### DETAILED DESCRIPTION

Disclosed herein are methods, systems, and apparatuses that may remove one or more piston rings from a piston. A tool with a tapered edge may be placed in a space between one or more rings and an associated piston. After the tool is placed, the piston may be rotated to remove the one or more rings.

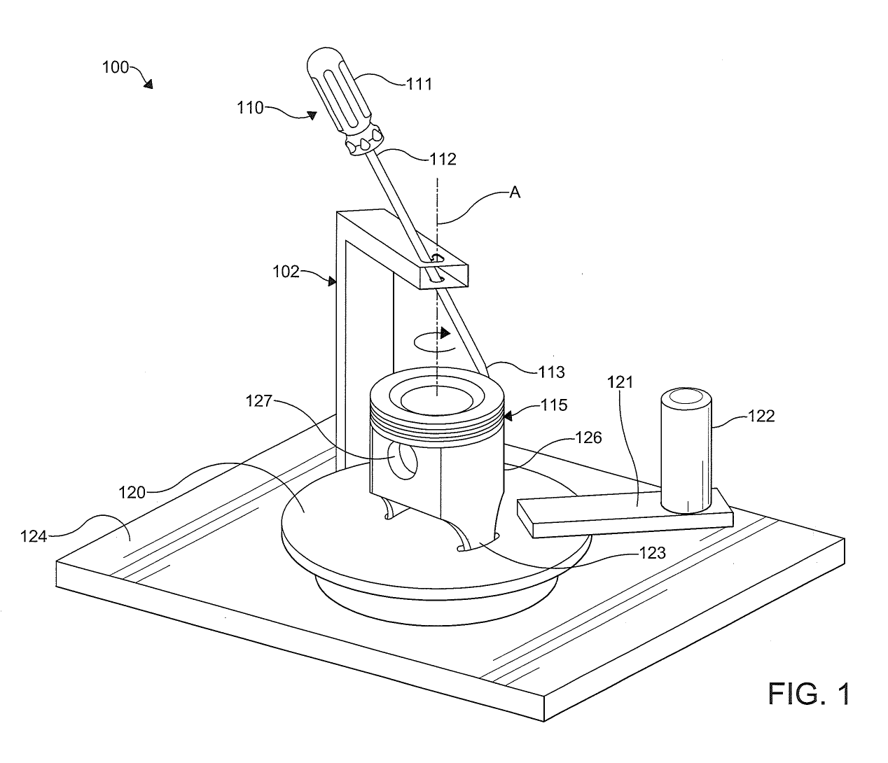

FIG. 1 illustrates a perspective view of a ring removal system 100. The ring removal system 100 may include a removal tool 110, a tool holder 102, and a rotatable surface 120. The ring removal system 100 may include other components in various configurations. The ring removal system 100 may be used to separate a first portion of an item from a second portion of an item. For example, the ring removal system 100 may be used to separate one or more piston rings from a piston 115.

In an aspect, the rotatable surface 120 and the tool holder 102 may rest upon a surface 124. The surface 124 may be table, a floor, or like surface. The rotatable surface 120 and the tool holder 102 may be on the same surface 124, as shown in FIG. 1, or on different surfaces. For example, the rotatable surface 120 may be disposed on a table (not shown) and the tool holder 102 may be disposed on a wall or other vertical surface. Other configurations may be used.

The rotatable surface 120 may include one or more notches 173, 174. The one or more notches 173, 174 have a shape that accommodates one or more portions of an item such as the piston 115. For example, the one or more notches 173, 174 may be configured to receive a lip 123 of a skirt 126 (e.g., a slipper skirt) of the piston 115. The placement of portions of the piston 115 in the notch 173 and the notch 174 may contribute in keeping the piston 115 stable and therefore stationary relative to the rotatable surface 120. Other mechanisms may be used to stabilize the piston 115. For example, a pin or insert may be configured to engage a portion of the piston 115 such as a bore 127 formed in the piston.

The rotatable surface 120 may be used to rotate the piston 115 around an axis A. As discussed herein, the piston 115 may be fastened to the rotatable surface 120, in order to keep the piston 115 from substantially moving during the removal process of the one or more piston rings. The arm 122 may be connected with the rotatable surface 120 via the extension 121. The rotatable surface 120 may be rotated around axis A by moving the arm 122 via a human user (not shown) or an electromechanical machine (not shown), for example. In an alternative aspect, the tool holder 102 may be rotated around axis A and the rotatable surface 120 may be held stationary.

In an aspect, the removal tool 110 may include a grip 111, an elongated shaft 112, and an end portion 113. As an example, the removal tool 110 may be configured to have a particular longitudinal length such as about 400 mm. However, other lengths may be used. The grip 111 may facilitate an interface between a user and the removal tool 110. As an example, the grip 111 may assist a user in maintaining an engagement (e.g., hand grip) with the removal tool 110.

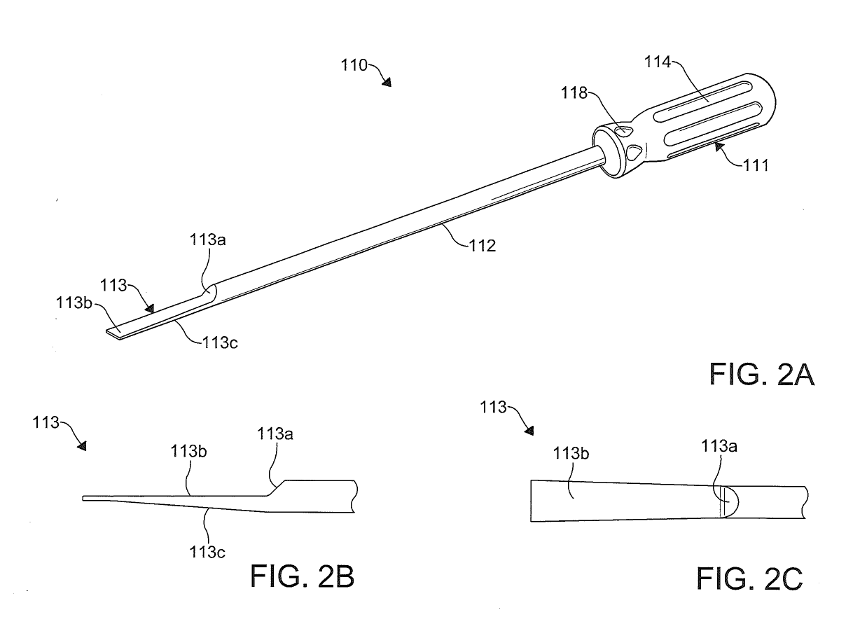

As more clearly shown in FIGS. 2A, 2B, and 2C, the grip 111 may have one or more first indentations 114 and/or one or more second indentations 118, among other indentations of varying shapes (for example oval or rectangular shapes), which facilitate gripping of the removal tool 110. The grip 111 of removal tool 110 may be connected with an elongated shaft 112. In an aspect, the end portion 113 is disposed opposite the grip 111 along the elongated shaft 112. Other configurations may be used.

In an aspect, the end portion 113 is constructed in a manner that allows insertion between one or more piston rings and a piston. The end portion 113 may be tapered so that the removal tool 110 may fit into an opening between one or more piston rings and a piston 115. The end portion 113 may have a flared tip. The end portion 113 may be tapered from a first thickness (e.g., 5 mm) to a second thickness (e.g., 1 mm) Other thickness and configurations may be used. As an example, the elongated shaft 112 of the removal tool 110 may have one or more tapered face 113a, 113b, 113c formed thereon to define an aspect of the end portion 113. As another example, the elongated shaft 112 may be cylindrical and taper faces 113a, 113b, 113c may be or comprise a planar surface. The tapered faces 113a, 113b, 113c may have varying angles of taper, size, shape, texture, and other characteristics as compared to each other. As a further example, one tapered face 113a may have a greater (e.g., steeper) angle of taper relative to a longitudinal axis of the elongated shaft 112 than the angle of taper of another tapered face 113b, 113c. As yet a further example, one tapered face 113b may be disposed on the same edge of the elongated shaft 112 as another tapered face 113a and/or on a different edge of the elongated shaft 112, such as tapered face 113c. Any number of tapered faces 113a, 113b, 113c having any shape, angle, size, and texture may be used. As discussed in more detail herein, the removal tool 110 may be angled such that one or more piston rings slide onto the end portion 113 during the removal process of the piston rings. The grip 111, the elongated shaft 112, and end portion 113 may be a single molded piece or modular in nature to form the removal tool 110.

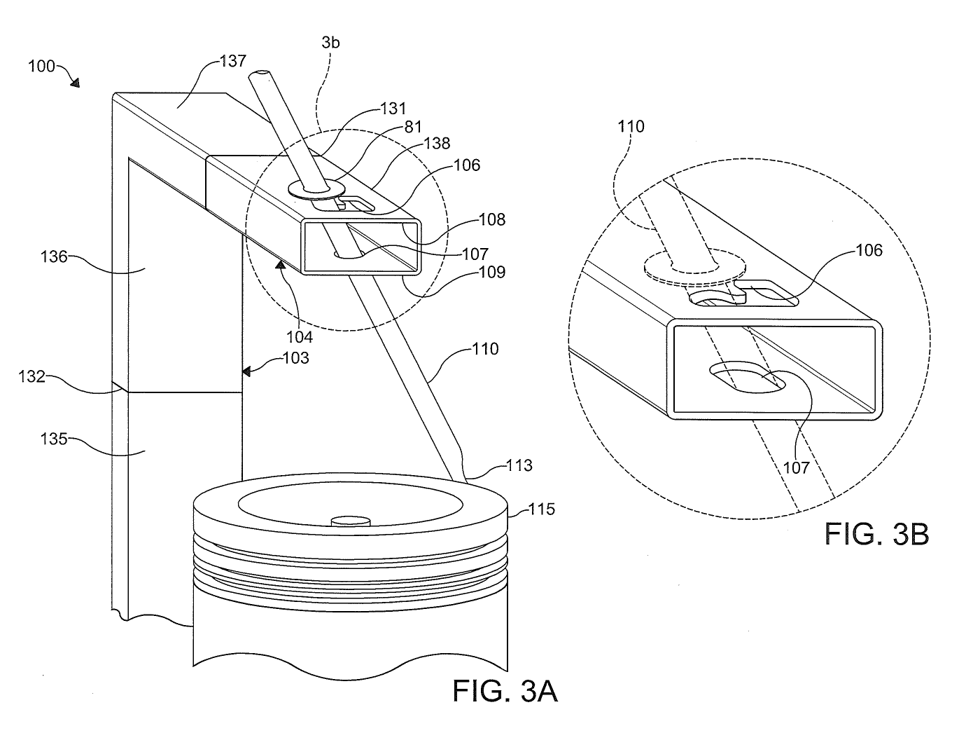

FIGS. 3A and 3B illustrate a perspective view of the tool holder 102. The tool holder 102 may be or include an L-shaped member including a vertical member 103 that is connected with a horizontal member 104. The horizontal member 104 may be partially hollow. The horizontal member 104 may have a top surface 108 that includes a top slot 106 formed therein. The horizontal member 104 may have a bottom surface 109 that includes a bottom slot 107 formed therein. In an aspect, the end portion 113 of the removal tool 110 and the elongated shaft 112 of the removal tool 110 may be of sufficient width to extend through the top slot 106 and the bottom slot 107. As an example, the top slot 106 may be J-shaped, L-shaped, or U-shaped. As another example, the bottom slot 107 may be oval shaped. As a further example, the bottom slot 107 and the top slot 106 may both be sized to receive the removal tool 110 and to allow for maneuvering of the removal tool 110 into the appropriate positions for removal of piston rings (e.g., from piston 115) as discussed in more detail herein. In certain aspects, the top slot 106 may have a “J” shape with the longer channel of the “J” having a length of about 30 mm (e.g., 29 mm, 29.5 mm, 30 mm, 30.5 mm, 31 mm etc.), a shorter channel of the “J” having a length of about 16 mm (e.g., 15 mm, 15.5 mm, 16 mm, 16.5 mm, 17 mm, etc.). Other sizes and configurations fo the top slot can be used. The piston 115 may be of different sizes and configurations, therefore the removal tool 110 may be placed in different positions to account for the configuration of the piston 115.

With further reference to FIG. 3, the removal tool 110 may include a brace 81, which may stabilize and keep elevated the removal tool 110 while disposed in the top slot 106 and the bottom slot 107. The brace 81 may be a washer, nut, or other formation that may be brazed, welded, fastened, glued, screwed, or otherwise attached to the removal tool 110. In another example, the brace 81 may be molded into or coupled to the elongated shaft 112 as part of the removal tool 110. The brace 81 may be configured to maintain the removal tool 110 in a locked position (e.g., fixed in one or more degrees of movement) during the removal process. As an example, the brace 81 may be configured to provide set angle orientation and depth locating of the removal tool 110 relative to the tool holder 102 and/or the piston 115. The brace 81 may be placed in a position on the elongated shaft 112 that allows for the end portion 113 of the removal tool 110 to reach one or more piston rings of the piston 115. The brace 81 may be configured to limit the movement of the removal tool 110 in one or more degrees of freedom for repeatability. For example, the brace 81 may be configured to minimize a movement of the removal tool 110 in a vertical direction such that the removal tool 110 extends through the top slot 106 and bottom slot 107 in a repeatable manner and having a pre-defined depth of extension.

The tool holder 102 may have varying shapes and configurations. In an aspect, the tool holder 102 may be configured to have the horizontal member 104 and the vertical member 103 be adjustable. For example, the horizontal member 104 may include a telescoping partition 138 that may be incrementally shortened to or extended from partition 137 at line 131. The partition 137 may be connected with the vertical member 103. In this regard, the telescoping partition 138 may extend horizontally from partition 137 to change a horizontal position of the top slot 106 with respect to the piston 115. The telescoping structure may be contained inside the partition 137 and/or the partition 138. The telescoping structure may further allow for locking of the partition 138 in a desired horizontal position.

In another example, the vertical member 103 may include a telescoping partition 136 that may be incrementally shortened to or extended from the partition 135 at the line 132. The partition 136 may be connected with the horizontal member 104. The horizontal member 104 or the vertical member 103, for example, may help accommodate the use of the removal tool 110 on the piston 115, which may be different sizes. In this regard, the telescoping partition 136 may extend vertically from partition 135 to change a vertical position of the top slot 106 with respect to the piston 115. The telescoping structure may be contained inside the partition 136 and/or the partition and 35. The telescoping structure may further allow for locking of the partition 136 in a desired horizontal position.

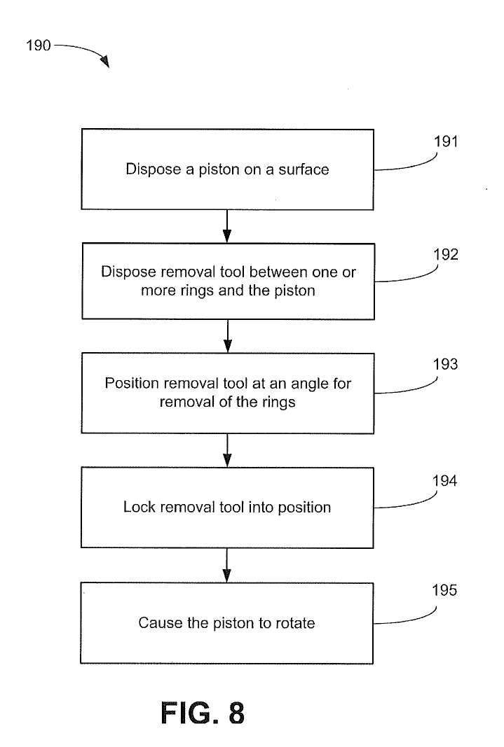

In an aspect, the top slot 106 may be J-shaped and the bottom slot 107 may be oval shaped. The top slot 106 and the bottom slot 107 may be of any shape that allow for maneuvering the removal tool 110 into position for the removal process. The removal tool may be disposed in various positions of the top slot 106 such as a first position (e.g., insert position) and a second position (e.g., removal position), based on the steps of the removal process, which is discussed in more detail with regard to method 190 of FIG. 8.

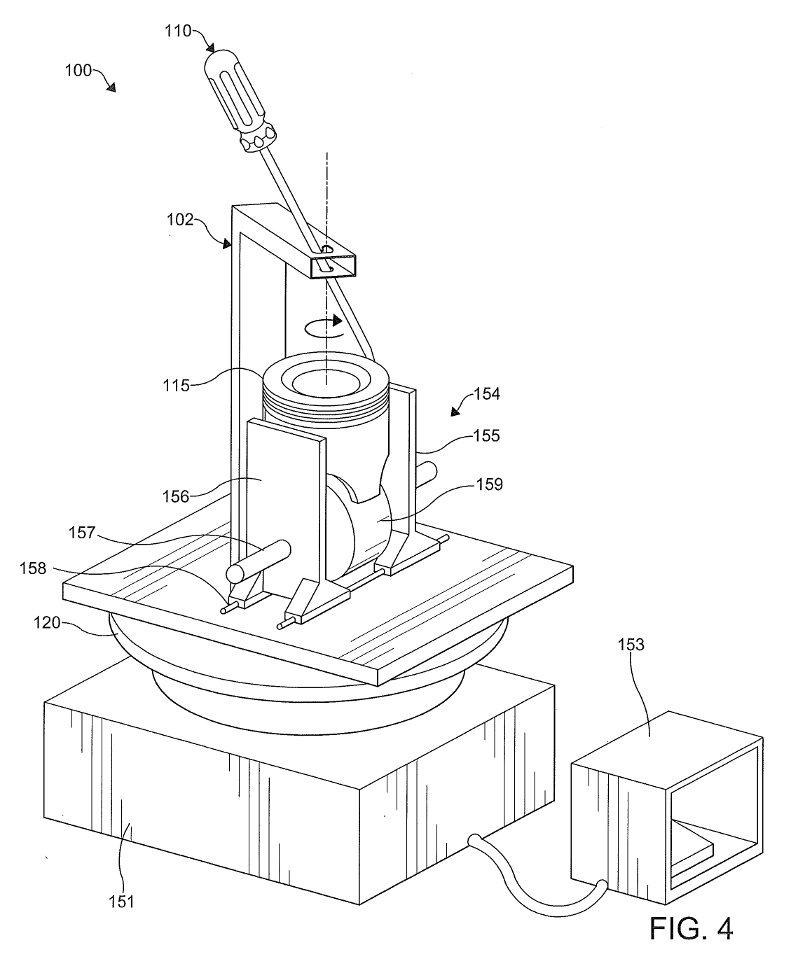

FIG. 4 illustrates an example of a ring removal system 100. The ring removal system 100 may include the removal tool 110, the tool holder 102, and a rotatable surface 120. The tool holder 102 may be coupled with a surface such as a table. The rotatable surface 120 may protrude through table and may be coupled with a base 151 that may mechanically or electromechanically turn the rotatable surface 120. The base 151 may be connected with a switch 153 that activates the rotation of the rotatable surface 120 coupled with the base 151. The rotatable surface 120 may rotate around axis A during the appropriate steps of the removal process as discussed herein. The switch 153 may be a mechanical button, mechanical lever, mechanical pedal, a virtualized switch on a graphical user interface, or the like. In one aspect, the switch 153 may operate a motor arranged in the base 151. The motor may be appropriately geared to rotate the rotatable surface 120 at an appropriate speed with sufficient power. In another aspect, the switch 153 may be a mechanical lever that may be mechanically connected to the rotatable surface 122 to rotate the same.

With further reference to FIG. 4, the rotatable surface 120 may be connected with stabilizing element or system such as a clamp 154. The clamp 154 may comprise railing 158, a sidewall 155, a sidewall 156, and a shaft screw 157. The sidewall 155 and the sidewall 156 may be adjusted along the shaft screw 157 in order to clamp or unclamp an object, such as piston 115. Clamp 154 may be operated mechanically or electromechanically, such as by hand or a motor 159 controlled by a computing device (not shown) or switch (not shown), in order to adjust the position of the sidewall 155 or the sidewall 156 along the railing 158. The sidewall 155 and the sidewall 156 may be coupled with a bore insert, such as a pin bore insert 171 that may be inserted within the bore 127 of the piston 115. As discussed in more detail below, the pin bore insert 171 may assist in keeping the piston 115 stationary.

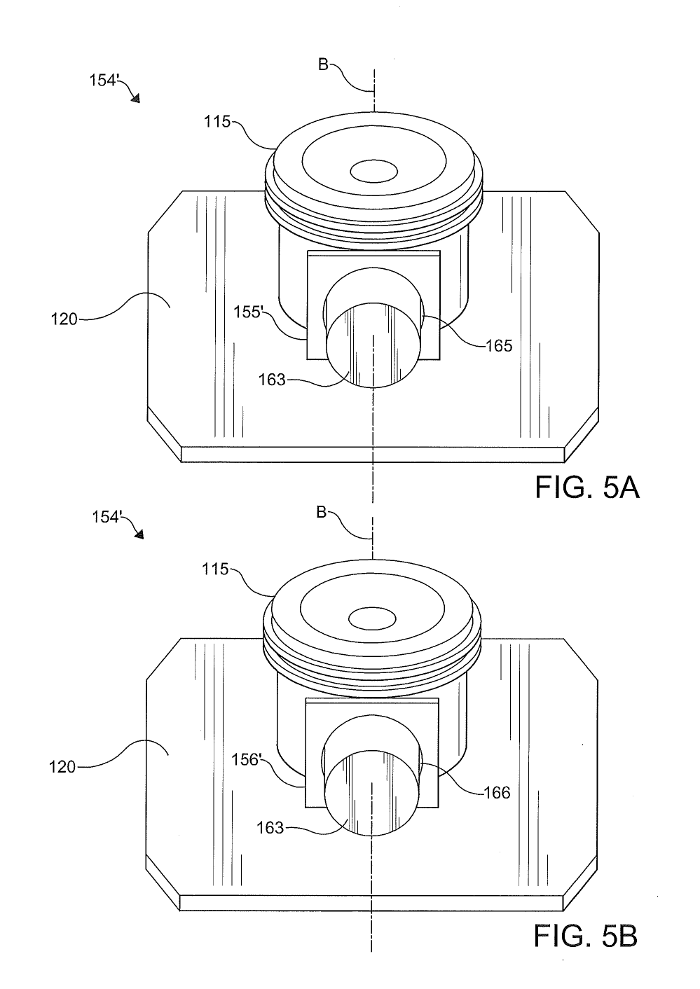

FIGS. 5A and 5B illustrate an example of a clamp 154′, according to another aspect, that may be used to hold the piston 115 stationary relative to a surface such as rotatable surface 120. The clamp 154′ may include one or more sidewalls 155′, 156′ and a pin bore insert 163. In an aspect, the sidewall 155′ may define an aperture 165 and the sidewall 156′ may define an aperture 166. The aperture 165 and the aperture 166 may be centered along an axis B and may be configured to receive the pin bore insert 163. The sidewall 155′ may be a distance away from the sidewall 156′ in order to accommodate the piston 115 resting therebetween. One or both sidewalls 155′, 156′, may be welded, glued, brazed, fastened, or otherwise attached with the rotatable surface 120. One or both sidewalls 155′, 156′, may be coupled to the rotatable surface 120, but readily adjustable in a way that may increase or reduce a distance between the sidewalls 155′, 156′, for example to accommodate piston 115.

In an aspect, the bore 127 formed in the piston 115 may be aligned with the aperture 165 and the aperture 166. As such, the pin bore insert 163 may be disposed through the bore 127 and the apertures 165, 166 to secure the piston 115 to the rotatable surface 120. In an aspect, the pin bore insert 163 may be cylindrical in shape. The pin bore insert 163 may be made substantially of or covered with a minimally abrasive material, such as plastic, foam (for example closed-cell extruded polystyrene foam), or the like, in order to minimize damage to piston 115 during the removal process as discussed herein.

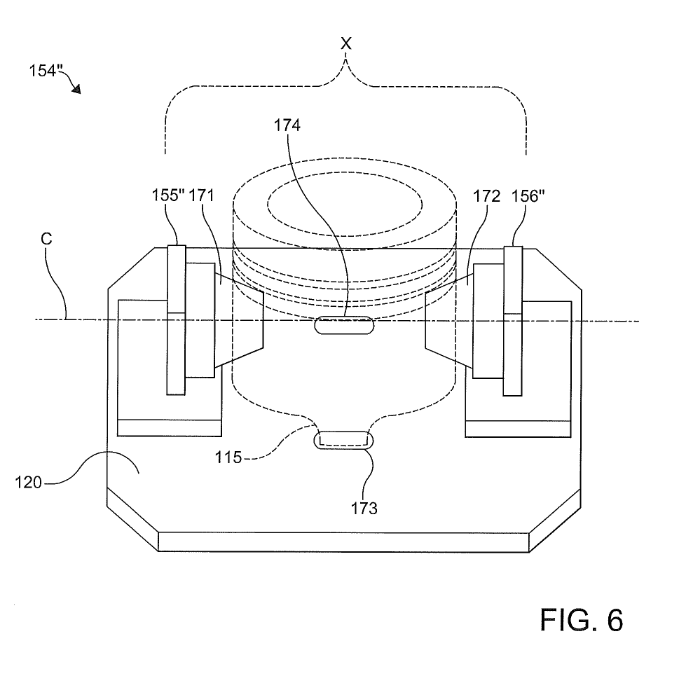

FIG. 6 illustrates another aspect of the disclosure comprising a clamp 154″ that may be used to hold the piston 115 stationary. The clamp 154″ may include one or more sidewalls 155″, 156″. The sidewall 155′ may have a pin bore insert 171 and the sidewall 156″ may have a pin bore insert 172. The pin bore insert 171 and the pin bore insert 172 are shown to be a conical shape, but may have a cylindrical shape, rectangular shape, or other shape. The conical shape of pin bore insert 171 and the pin bore insert 172 may help to accommodate pistons with pin bores of different dimensions. The pin bore insert 171 or the pin bore insert 172 may be readily adjustable along their respective sidewalls, the sidewall 155″ and the sidewall 156″. For example, the sidewall 155″ or the sidewall 156″ may have a telescoping nature as similarly discussed with other apparatuses herein. Adjustment of the height or horizontal direction of the pin bore insert 171 or the pin bore insert 172 may accommodate pistons of different dimensions. The pin bore insert 171 and the pin bore insert 172 may be centered along an axis C.

With further reference to FIG. 6, the sidewall 155″ may be a distance X away from sidewall 156″ in order to accommodate piston 115 resting therebetween. One or both sidewalls, sidewall 155″ or sidewall 156″, may be welded, glued, brazed, fastened, or otherwise attached with the rotatable surface 120. One or both sidewalls, sidewall 155″ or sidewall 156″, may be attached to the rotatable surface 120, but readily adjustable in a way that may increase or reduce distance X to accommodate the piston 115. The rotatable surface 120, as shown in FIG. 6, may include the notches 173, 174, which may be configured to receive a portion of an item such as the piston 115. As an example, the placement of portions of the piston 115 in the notch 173 and the notch 174 may contribute in keeping the piston 115 stable and therefore stationary.

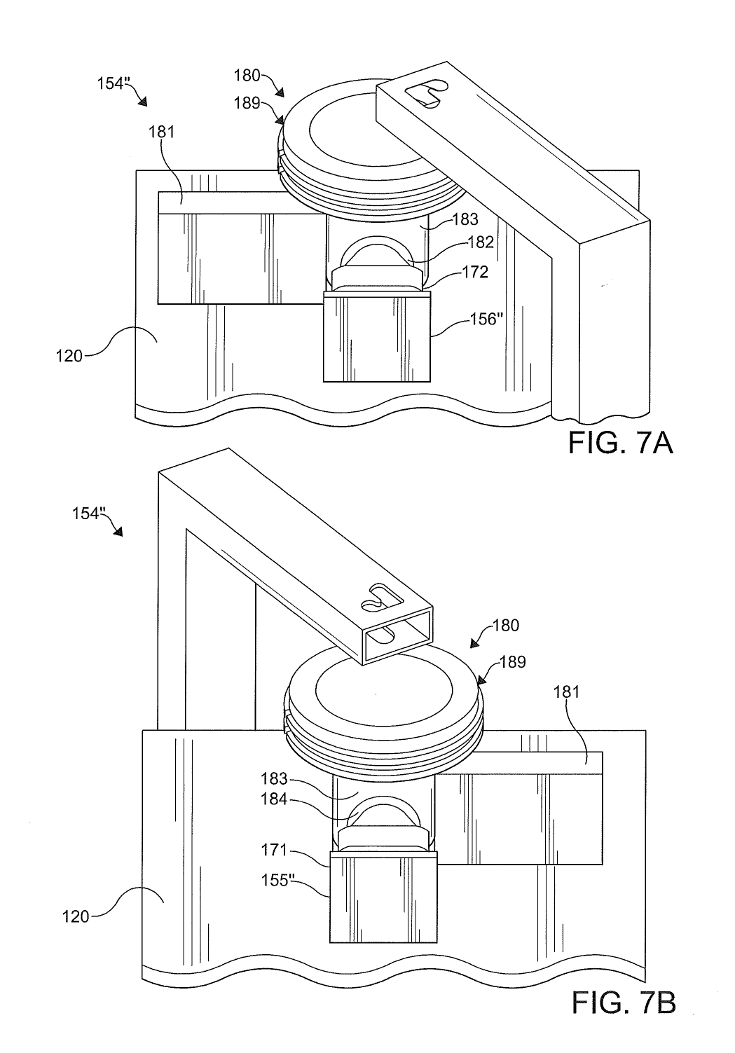

FIGS. 7A and 7B illustrate an example of the clamp 154″ with an item such as a piston bore-crown assembly 180. As shown, the piston bore-crown assembly 180 does not have a conventional piston skirt. The piston bore-crown assembly 180 may be a part of multiple piece system (e.g., two-piece pistons). As an example, a stabilizing insert 181 may be located between a wall 183 that defines a bore 182 and a wall 185 that defines a bore 184. The wall 183 and the wall 185 may be rounded; therefore the piston bore-crown assembly 180 may have a tendency to tip or otherwise move when placed to stand upright on the wall 183 and the wall 185, even when clamped. The stabilizing insert 181 may be used to stabilize the piston bore-crown assembly 180 on rotatable surface 120, which may be beneficial during the removal process.

With continued reference to FIGS. 7A and 7B, the stabilizing insert 181 may be in the shape of a rectangular cuboid (in other words box shaped) and have dimensions such that the piston bore-crown assembly 180 may be level when the stabilizing insert is placed in a space between the wall 185 and the wall 186. Other shapes such as polygons are contemplated as well. The stabilizing insert 181, when inserted in the space between the wall 185 and the wall 186, may make the pin bore-crown assembly as stable on the rotatable surface 120 as a piston with a conventional piston skirt, such as the piston 115. The stabilizing insert 181 may be constructed of or covered with a minimally abrasive material, such as plastic, foam (for example closed-cell extruded polystyrene foam), or the like in order to minimize damage to piston bore-crown assembly 180. The stabilizing insert 181 may be rigidly fixed to the rotatable surface 120 or removable.

### INDUSTRIAL APPLICABILITY

In general, the technology described in the disclosure has industrial applicability in a variety of settings such as, but not limited to, reducing the time to remove piston rings, while protecting a piston from damage. Its industrial applicability extends to virtually all pistons, including pistons from automobiles, buses, trucks, tractors, off road machines, generator sets, marine vessels, aircraft, and industrial work machines, or the like. In addition, the disclosed methods, systems, and apparatuses allow ways to clamp pistons, rotate pistons, hold tools, as well as efficiently remove piston rings from a piston.

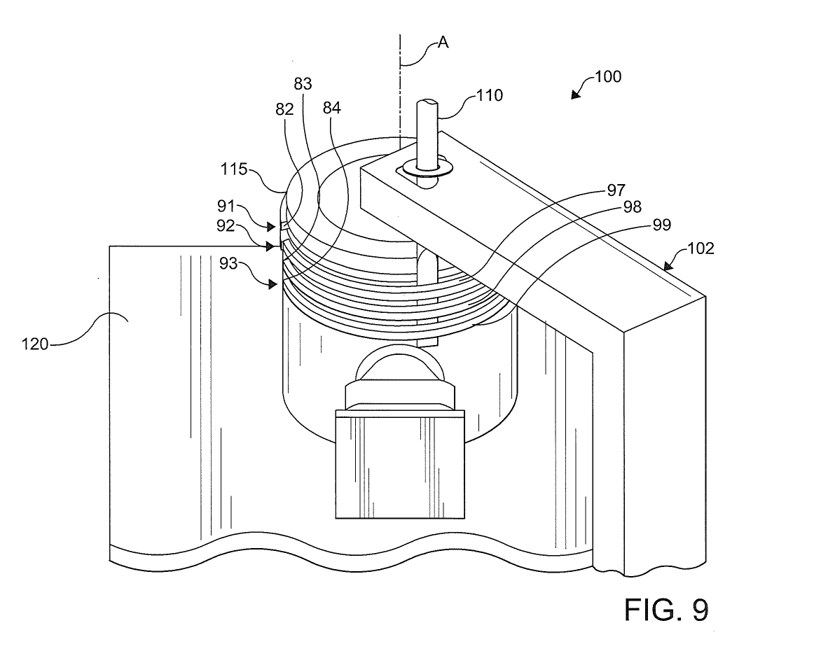

FIG. 8 illustrates an exemplary method 190 for removing one or more piston rings from a piston. Referring to FIGS. 8 and 9, at step 191, the piston 115 may be disposed on a surface such as the rotatable surface 120. The piston 115 may be clamped or otherwise held stationary (for example by hand), as discussed herein. The piston 115 may have a plurality of ring grooves, such as a top ring groove 91, second ring groove 92, and an oil ring groove 93 that may include a plurality of rings, such as, respectively, a top compression piston ring 97, a second compression piston ring 98, and an oil control piston ring 99, as shown in FIG. 9. The piston ring 97, the piston ring 98, and the piston ring 99 may include, respectively, a ring gap 82, a ring gap 83, and a ring gap 84. At step 192, the removal tool 110 may be disposed (e.g., inserted) between the piston 115 and one or more of the piston rings (the top compression piston ring 97, the second compression piston ring 98, and the oil control piston ring 99), as shown in FIG. 9. Pressure may be applied to the plurality of piston rings in order to assist in creating enough space to insert the removal tool 110 with regard to step 192. For example, on the side (not shown) of the piston 115 that is opposite the anticipated position of the removal tool 110, the plurality of piston rings may be pressed in a direction towards the anticipated position of the removal tool 110. The pressure may be towards the center of the piston 115. As shown in FIG. 9, during the insertion of the removal tool 110 at step 192, the removal tool 110 may be parallel to axis A of the piston 115. At step 192, the removal tool 110 may be positioned in a first position (e.g., insert position) of the top slot 106. Other configurations and placements may be used.

With further reference to the step 192 of FIG. 8, the removal tool 110 may be inserted at a position near the ring gaps of the plurality of piston rings that are anticipated to be removed. The ring gaps of the plurality of piston rings, as shown in FIG. 9, may be repositioned to be aligned near the anticipated position of the removal tool 110, before the removal tool 110 is inserted.

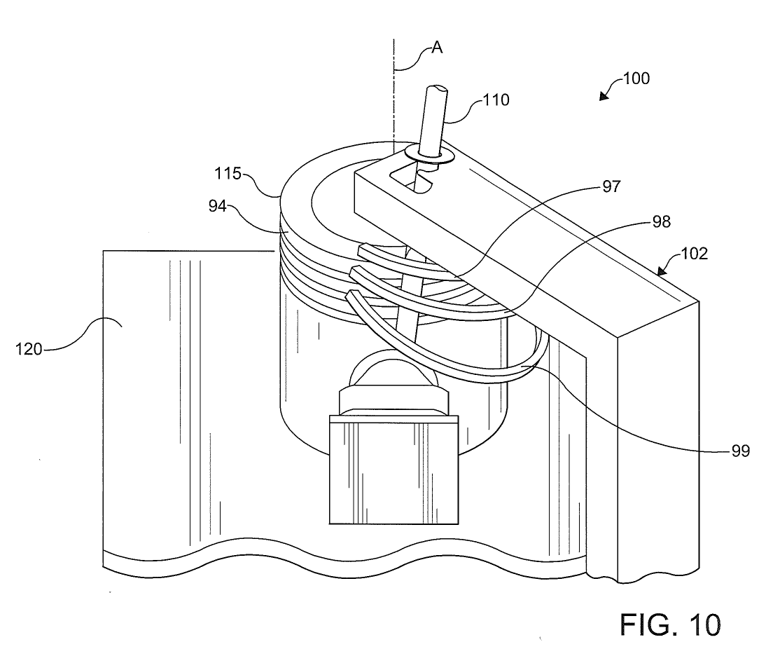

At step 193 of FIG. 8, the removal tool 110 may be positioned (for example angled) in a manner that may cause the plurality of piston rings to be elevated above operating ring groove positions to a position near or above a top land 94, as shown in FIG. 10. As discussed above, the removal tool 110 may be near the ring gaps of the plurality of piston rings, therefore ring ends as highlighted by oval may be elevated near or above the top land 94 of piston 115, as shown in FIG. 10.

At step 194 of FIG. 8, the removal tool 110 may be locked into position so that the ends of the plurality of piston rings are near the top land 94 of the piston 115. The removal tool 110 may be locked into its position based on the positioning of the elongated shaft of the removal tool in bottom slot 107 and top slot 106. The positioning of the removal tool 110 may vary based on the dimensions of the piston 115, among other factors as discussed herein. During the locking process of step 194, the removal tool 110 may be positioned in a second position (e.g., removal position) of the top slot 106. If the tool is manually operated, the user may let go after locking of the removal tool 110. The positioning of the removal tool at step 194 may allow for the plurality of piston rings to slide up the removal tool and out of their respective grooves when the piston 115 is rotated.

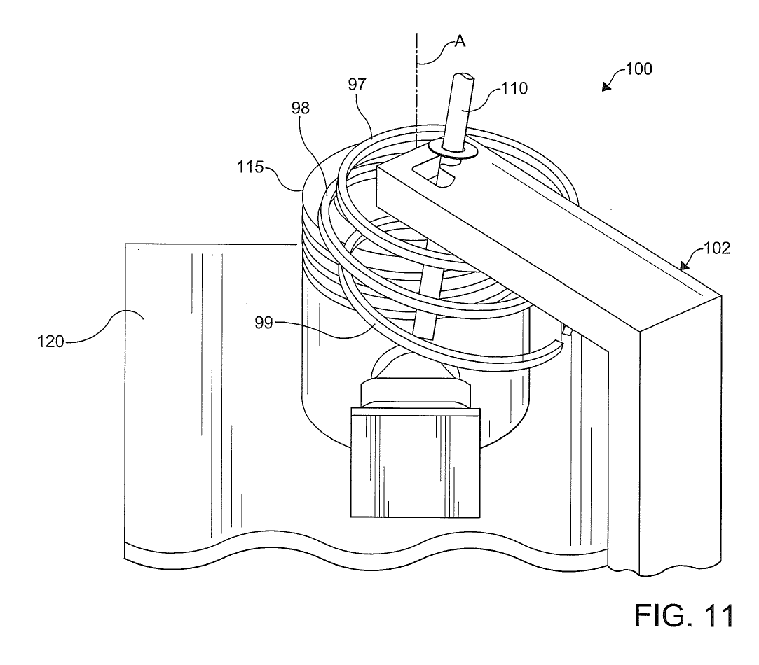

At step 195, the piston 115 may be caused to rotate in order to separate the one or more piston rings from their previously situated ring grooves. The piston 115 may be rotated around axis A in any manner, such as by rotating the rotatable surface 120 via arm 122 (FIG. 1). The arm 122 may be moved to rotate rotatable surface 120. FIG. 11 is an exemplary illustration of the piston 115 rotated 180 degrees. As shown in FIG. 11, the plurality of piston rings 97, 98, 99 are at least partially separated from the piston 115 and substantially removed from their respective ring grooves.

The use of the method 190 may allow for the removal of one or more piston rings with minimal to no damage to the piston 115. In addition, method 190 may allow for the removal of one or more piston rings in a relatively short amount of time when compared to conventional methods of removing piston rings.

It is contemplated herein, that the tool holder 102 may not be in the form as shown. A user, with no other mechanical apparatus, may hold the removal tool 110. In this scenario, the piston 115 may be rotated, while the user holds the removal tool 110 at an appropriate angle to remove one or more piston rings, as similarly discussed in method 190. The tool holder 102 and the removal tool 110 may also be integrated, as in an automated manufacturing environment, such that the removal tool 110 may be controlled by or be part of a robotic arm or the like.

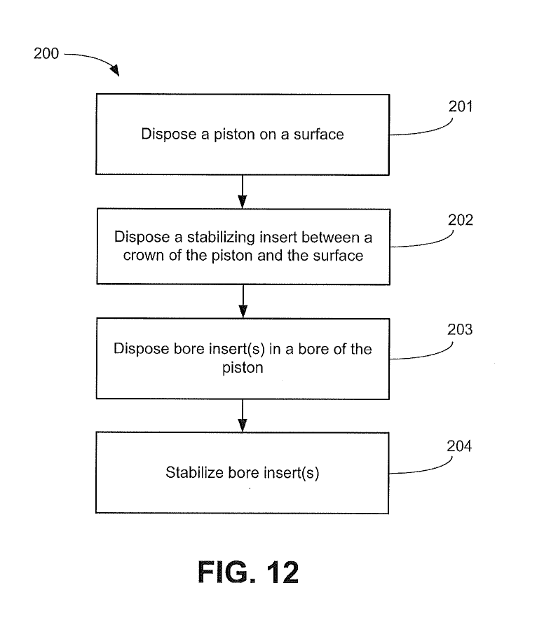

FIG. 12 illustrates an exemplary method 200 for clamping an item such as a piston element (e.g., piston 115, piston bore-crown assembly 180, etc.). In an aspect, at step 201, the piston bore-crown assembly 180 (FIGS. 7A-7B) may be disposed on a surface such as the rotatable surface 120. At step 202, an insert such as the stabilizing insert 181 may be disposed between the crown 189 of the piston bore-crown assembly 180 and the surface. At step 203, one or more bore inserts (e.g., the pin bore inserts 171, 172) may be inserted, respectively, through bore 184 and bore 182. As an example, the pin bore insert 171 and/or the pin bore insert 172 may contact the stabilizing insert 181. At step 204, one or more of the pin bore inserts 171, 172 may be secured in a temporary fixed position. In an aspect, one or more of the sidewall 155″ and the sidewall 156″ associated with the pin bore inserts 171, 172 are held stationary by a fastening or locking mechanism. As an example, the sidewalls 155″, 156″ may be held stationary by locating pins that are removeably secured to the rotatable surface 120. As a further example, the sidewalls 155″, 156″ may include brackets having apertures configured to receive a pin such that the pin extends through the bracket and engage the rotatable surface 120. Other configurations may be used. The method 190 may be implemented after the implementation of this method 200.

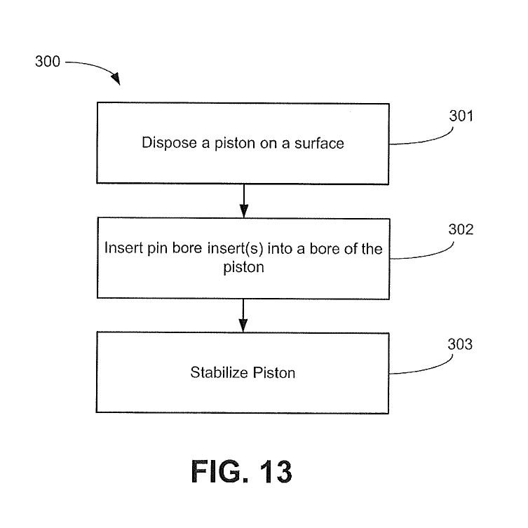

FIG. 13 illustrates an exemplary method 300 for clamping an item such as piston 115. At step 301, the piston 115 may be disposed on a surface such as the rotatable surface 120 (FIG. 6). At step 302, the pin bore insert 163 may be inserted through the bore 127 of the piston 115. At step 303, the piston 115 may be stabilized. As an example, the sidewall 155″ and the sidewall 156″ may be held stationary by a fastening or locking mechanism. In another example, the sidewall 155″ or the sidewall 156″ may be rigidly fixed to rotatable surface 120 via a weld or braze. The method 190 may be implemented after the implementation of this method 300. As such, when the rotatable surface 120 rotates, the piston 115 is stabilized relative to the rotatable surface 120.

It will be appreciated that the foregoing description provides examples of the disclosed system, structure, and methods. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value within such range should be construed as if it were individually recited herein. All methods described herein may be performed in any suitable order unless otherwise indicated herein or otherwise clearly contradicted by context.

We claim:

1. A method comprising:
disposing a tool between a first piston ring and a piston associated with the piston ring; and
rotating the piston, wherein the tool engages the first piston ring and separates at least a portion of the first piston ring from the piston.

2. The method of claim 1, wherein the tool comprises a tapered portion and wherein disposing the tool between the first piston ring and the piston comprises disposing the tapered portion of the tool between the first piston ring and the piston.

3. The method of claim 1, further comprising arranging the tool in a tool holder disposed in proximity to the piston.

4. The method of claim 3, wherein the tool holder comprises one or more slots configured to receive at least a portion of the tool.

5. The method of claim 4, wherein the one or more slots comprise at least one of the following: an oval slot, a U-shaped slot, an L-shaped slot, and a J-shaped slot.

6. The method of claim 1, further comprising clamping the piston to a rotatable surface, wherein rotating the piston further comprises rotating the rotatable surface to rotate the piston.

7. The method of claim 1, further comprising disposing an insert within a bore formed in the piston to stabilize the piston.

8. The method of claim 1, further comprising, subsequent to disposing the tool between the first piston ring and the piston, positioning the tool in a removal position, wherein the removal position limits the movement of the tool in at least one direction.

9. The method of claim 1, further comprising, subsequent to disposing the tool between the first piston ring and the piston, positioning the tool to cause at least a portion of one or more of the plurality of piston rings to be disposed adjacent a top land of the piston.

10. A removal system comprising:
a rotatable surface configured to rotate about an axis; and
a removal tool comprising a tapered portion, wherein the tapered portion of the removal tool is configured to engage an item disposed on the rotatable surface, and wherein a rotation of the rotatable surface causes the removal tool to separate a first portion of the item from a second portion of the item.

11. The system of claim 10, wherein the first portion of the item is a piston ring and the second portion of the item is a piston groove.

12. The system of claim 10, further comprising a tool holder configured to receive at least a portion of the removal tool and to position the removal tool relative to the rotatable surface.

13. The system of claim 10, further comprising a tool holder having one or more slots configured to receive at least a portion of the removal tool.

14. The system of claim 13, wherein the one or more slots comprise at least one of the following an oval slot, a U-shaped slot, an L-shaped slot, and a J-shaped slot.

15. The system of claim 10, further comprising a clamp configured to engage the item, wherein the clamp is coupled to the rotatable surface.

16. The system of claim 10, wherein the item comprises a piston and the rotatable surface comprises a notch configured to hold a skirt of the piston.

17. The system of claim 10, further comprising a clamp configured to engage the item, wherein the clamp comprises a sidewall including an insert configured to pass into a bore formed in the item.

18. The system of claim 10, wherein the removal tool comprise a grip disposed along an elongate shaft and the tapered portion is formed in an end of the elongate shaft opposite the grip.

19. The system of claim 18, wherein the grip of the removal tool comprises one or more indentations.

20. The system of claim 10, wherein the tapered portion of the removal tool comprises two or more tapered faces having different angles of taper relative to a longitudinal axis of the removal tool.
